(19) United States
(12) Patent Application Publication
(10) Pub. No.: US 2002/0192131 A1
(43) Pub. Date: Dec. 19, 2002

(54) Device for protecting plants against post-harvest decay and method for making same

(75) Inventors: Joseph Dussaud, Vienne (FR); Laurent Bonduelle, Paris (FR)

Correspondence Address: HESLIN ROTHENBERG FARLEY & MESITI PC, 5 COLUMBIA CIRCLE, ALBANY, NY, 12203, US

(73) Assignee: AHLSTROM RESEARCH AND COMPETENCE CENTER, Pont Eveque (FR)

(21) Appl. No.: 10/202,038

(22) Filed: Jul. 24, 2002

Related U.S. Application Data
(63) Continuation of application No. PCT/FR01/00154, filed on Jan. 18, 2001.

(30) Foreign Application Priority Data
Jan. 28, 2000 (FR) 00.01103

(51) Int. Cl. B01D 53/02

(52) U.S. Cl. 422/187; 422/211

(57) ABSTRACT

The present invention relates to compositions for protecting plants, including, for example, fruits, vegetables, plants and flowers, against decay, and methods of making the compositions. A composition according to the invention includes a substrate coated with an adhesive layer, the surface of the adhesive layer covered with a film comprising a powder mixture that includes at least one substance capable of adsorbing ethylene released by the plant, and at least one substance, an oxidizing agent, capable of degrading ethylene. In order to reduce the quantity of powder needed to protect plants, the powder mixture is in the form of individualized grains existing as a film at surface of the adhesive layer. Part of the grain surface remains outside of the adhesive layer, thereby making the grain active toward the degradation of ethylene.

The invention relates to a device for protecting plants against post-harvest decay. It also relates to the method for making said device.

In the remainder of the description and in the claims, the term “plants” denotes any plant material including, without limit, fruit, vegetables, plants, flowers and the like.

The phenomena responsible for post-harvest plant decay are known. Essentially, plants release a number of gases which themselves stimulate the production of gases such that the system is continually self-fed until there is complete decay of the plant. In addition, the emission of gas leads to the formation of molds and to the development of bacteria. Among the gases released are essentially carbon dioxide and ethylene. It has, in addition, been demonstrated that the presence of carbon dioxide tended to reduce the emission of ethylene.

To protect against the post-harvest decay of plants, various solutions have been sought which are aimed at degrading ethylene through the breaking of the double bond in the molecule.

Thus, it has been proposed in the document U.S. Pat. No. 4,235,750 to adsorb the ethylene released by the plant on an activated alumina powder, and then to oxidize the ethylene thus bound by means of an oxidizing agent of the potassium permanganate type. The presence of water being necessary for the oxidation reaction, the composition described comprises, in addition, an activated silica gel intended to adsorb the moisture present in the atmosphere. In practice, the powder is introduced either in bags, in an amount of 10 to 30 g per bag, or in numerous compartments of rectangular plates, the plate being covered with a film allowing the passage of gases.

In the document EP-A-0 071 533, the silica gel was replaced by a hygroscopic salt of the calcium chloride type. The powder mixture obtained is placed in an amount of 20 g in a bag made of nylon cloth which is permeable to air.

The two devices described in the above-mentioned documents have the disadvantage of using a large quantity of product, of the order of 20 g on average, leading to a considerable increase in the cost of the treatment.

Furthermore, when the plants are stored, for example in crates, as is the case for fruit and vegetables, or in containers, as is the case for flowers, the devices described, given their bulkiness, can only be positioned near a number of them. It follows that the plants are not uniformly preserved.

In addition, even though the document EP-A-0 071 533 shows that the composition described makes it possible to reduce the ethylene level over eight days, nothing is indicated as to the behavior of the plants beyond this period.

Consequently, the problem which the invention proposes to solve is to provide a device for protecting plants against post-harvest decay, requiring the use of a small quantity of active ingredient through the elimination of the ethylene released, while maintaining, or even increasing, the long-term efficacy of said ingredient compared with the solutions proposed in the prior art.

Another objective of the invention is to bring about the uniform preservation of plants during their storage, independently of their volume.

To do this, the invention proposes a device for protecting plants against decay, comprising a mixture of powders capable of adsorbing, then eliminating, by breaking of the double bond, the ethylene released by said plants.

This device is characterized in that it is in the form of a substrate coated with an adhesive layer, whose surface is covered with said powder mixture, which is in the form of a film of single-unit and individualized grains.

According to an essential characteristic of the device, the powder is deposited at the surface of the adhesive layer, such that part of the surface of each grain constituting the powder is not enclosed in said adhesive layer but outside it. It follows that each grain is made active toward the degradation of ethylene, thus leading to the required quantity of powder being considerably reduced compared with the prior art devices. In addition, the grains are deposited so as to form a very fine layer of single-unit, that is to say nonsuperposed individualized, grains, the thickness of the film of grains substantially corresponding to the size of the grains. This characteristic, added to the fact that the distribution of the grains on the substrate is made so as to be homogeneous, makes it possible to have a surface whose activity is optimum in relation to the quantity of powder deposited.

The degradation phenomenon is slowed down according to the same principles as those described above, namely, mainly the binding of ethylene to an inert material, then breaking of the double bond of the gas, especially by an oxidation reaction.

Consequently, to allow the ethylene released by the plant to be adsorbed, the mixture of powders comprises an inert material chosen from the group comprising activated alumina, activated charcoal, clay, dolomite, zeolite, diatoms, perlite, bentonite, activated kaolin, titanium dioxide, alone or as a mixture. Of course, the larger the specific surface area of the inert material, the greater the adsorption of gases.

In addition, some of the inert materials chosen to bind the ethylene also have an oxidizing power. The oxidizing power of dolomite toward ethylene due to the quantity of manganese which it contains will be noted in particular.

Likewise, to allow the binding of water when ethylene is degraded by an oxidizing agent, the mixture of powders also contains a hygroscopic salt chosen from the group comprising calcium, magnesium, sodium or potassium chloride, nitrate, carbonate or sulfate, calcium or magnesium hydrides, and polyphosphates, alone or as a mixture.

To bring about the breaking of the double bond in ethylene by oxidation, once the gas is bound to the adsorbent material, the mixture of powders also contains an oxidizing agent chosen from the group comprising potassium salts, advantageously potassium permanganate, sodium salts, manganese sales, osmium tetroxide, alone or as a mixture.

To promote the formation of carbon dioxide, which tends to reduce the level of ethylene emission, the mixture of powders comprises, in addition, sodium carbonate or bicarbonate.

Moreover, the applicant has observed, quite surprisingly, that the incorporation into the powder of iodine salts or of pure iodine, alone or as a mixture, made it possible to considerably reduce the level of ethylene released.

Consequently, the invention also relates to a composition for protecting plants against post-harvest decay by adsorption onto an inert material and then elimination of the ethylene released, characterized in that it comprises iodine salts or pure iodine, capable of breaking the double bond in ethylene.

In an advantageous embodiment, the composition comprises between 5 and 30% by weight of iodine salts or pure iodine.

To solve the problem of providing a device which acts uniformly with respect to all fruits and vegetables or flowers, in particular during their storage, the substrate chosen is a fibrous substrate or a nonfibrous substrate.

Consequently, the flexibility of the substrate makes it possible to package all the plants to be preserved, thus placing the device in direct contact with, or in close proximity to, each of the plants, using a minimum of material.

Among the fibrous substrates, packaging paper of the glassine, parchment paper and kraft paper type in particular are advantageously chosen.

When the substrate is a nonfibrous substrate, it is in the form of a plastic film, whose constituent material is chosen from the group comprising polyethylene, polypropylene, cellophane, alone or as a mixture.

To allow binding of the active powder to the substrate, the device comprises, in addition, an adhesive layer comprising a binding agent chosen from the group comprising starch, carboxymethylcellulose, polyvinyl alcohol, emulsifiable homo- or copolymers of the acrylic, styrene and butadiene type and derivatives, alone or as a mixture.

To obtain an effective adhesion of the powder, the concentration of binding agent in the adhesive layer is between 1 and 20%, advantageously 5% as dry matter.

For a concentration of less than 1%, the powder does not adhere to the substrate.

For a concentration greater than 20%, no additional effect is obtained.

Of course, the adhesive layer is manufactured in a known manner by dissolving the binding agent in an appropriate solvent which is chosen according to the nature of the binding agent.

In addition, the adhesive layer is coated on the substrate in an amount of 0.5 to 15 g/m² according to the nature of the binding agent selected, advantageously 3 g/m² on a dry basis.

According to another characteristic of the invention, the powder is deposited on the adhesive layer in an amount of at least 0.1 g/m² on a dry basis, advantageously 2 to 5 g/m².

Of course, the mass of powder to be deposited will be chosen according to the activity and the volume of plants to be treated, the deposit not exceeding 60 g/m².

The method for manufacturing the powder, as described in the prior art and consisting in simply mixing all the powders, is not satisfactory since it has the disadvantage of leading to a powder in which the size and the distribution of the grains in the final powder are not homogeneous. Consequently, the quantity of powder intended to be deposited on the substrate is not optimum, since a large portion of the active surface of the powder may be kept inside the adhesive layer. In addition, the efficacy of the powder is not uniform.

To solve this problem, the invention proposes manufacturing the mixture of powders according to the following method which consists:

in mixing, with stirring, the various constituents of the mixture of powders with water until a paste is obtained;

then, in extruding the paste thus obtained, through a die;

in then evaporating the water by drying;

in then grinding the product obtained until a powder is obtained;

finally, in calibrating the powder by sieving.

In practice, the size of the grains constituting the mixture of powders is between 20 and 500 micrometers, advantageously 150 micrometers.

The method for making the device of the invention comprises the following steps:

the adhesive layer is first of all coated onto the substrate;

then, the powder is deposited on said adhesive layer so as to obtain a fine film of homogeneously distributed single-unit and individualized grains,

finally, the complex obtained is dried so as to evaporate the solvent present in the adhesive layer.

The coating of the adhesive layer is carried out by any known means of the air knife, leveling bar or smoothing blade type.

Moreover, the powder is deposited on the adhesive layer by a mechanical process of the cylinder or vent, curtain or nozzle spraying type.

In all cases, the operating parameters for the various materials are determined so as to obtain the deposition of a fine film of powder, in which the grains remain individualized and not superposed.

Thus, for example, in the case of the rotating cylinder whose diameter is between 10 and 70 centimeters, advantageously 50 centimeters, the speed of rotation of the cylinder will be between 100 and 600 revolutions/minute, advantageously 150 revolutions/minute.

In parallel, the substrate coated with the adhesive layer passes under the powder curtain at a speed of between 100 and 200 meters per minute, advantageously 150 meters per minute.

In practice, the drying is carried out at a temperature of between 100 and 150° C., advantageously 130° C. for 1 to 30 seconds, advantageously 5 seconds.

The invention and the advantages resulting therefrom will emerge more clearly from the following exemplary embodiment.

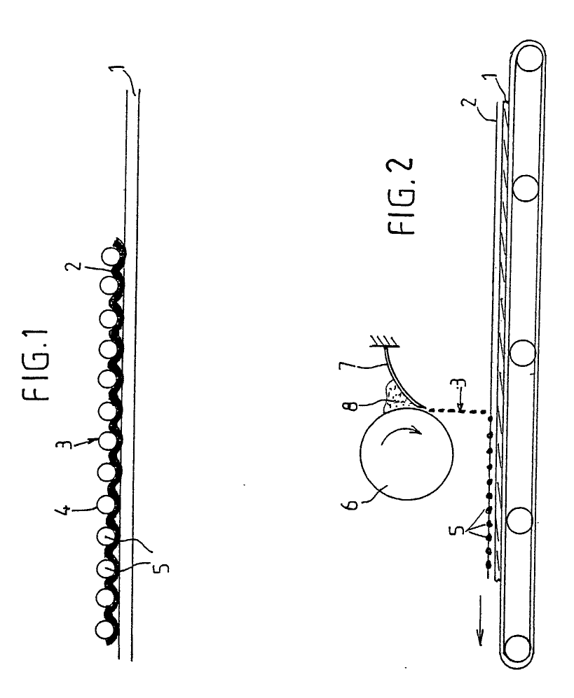

FIG. 1 is a schematic representation of the structure of the device of the invention.

FIG. 2 is a representation of the rotating cylinder used for depositing the powder.

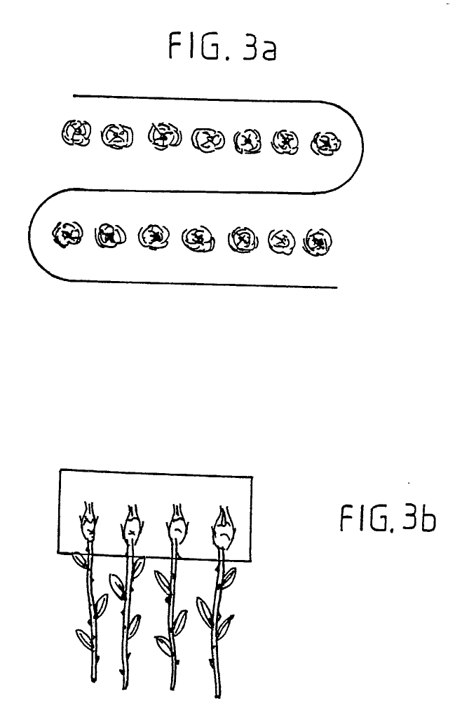

FIG. 3 (3a, 3b) is a representation of the device of the invention when it is used for the preservation of roses.

The device manufactured in the following example comprises a fibrous substrate constituting a packaging paper. This packaging paper is intended more particularly for the preservation of cut roses.

1/Composition of the Powder

| | |
|---|---|
| Dolomite | 20% by weight |
| Clay | 30% by weight |
| NaCl | 20% by weight |
| Pure iodine | 30% by weight |

2/Manufacture of the Powder

The powder mixture is prepared as follows.

Each of the constituents is first of all mixed with water in a sufficient quantity to obtain a paste. The paste is then extruded through a die and then dried until complete evaporation of the water is obtained. The product obtained is then ground, and then calibrated to a particle size equal to 150 micrometers by sieving.

3/Manufacture of the Device

In FIG. 1, there has been schematically represented the structure of the device, which comprises the substrate (1), the adhesive layer (2) and the mixture of powders (3). As shown in this figure, the mixture of powders (3) is deposited on the adhesive layer (2) such that part (4) of the surface of the grains (5) is not enclosed in the adhesive layer (2). In addition, the grains are individualized and not superposed, leading to a film whose thickness is equal to the size of the grains. It follows that the activity of the device is high despite the small quantity of powder required.

The device of FIG. 1 is obtained by the following process.

An adhesive layer, whose binding agent (polyvinyl alcohol) concentration is equal to 100% as dry matter, is coated by an air knife on a substrate composed of 100% of cellulosic fibers designated glassine, marketed by AHLSTROM. The coating is carried out at the rate of 3 g/m2 on a dry basis, that is 30 μm thick.

The powder is then deposited on the substrate (1) coated with the adhesive layer (2).

To do this, a metal cylinder (6) equipped with a blade (7) is positioned above the coated substrate. More precisely, the blade (7) presses against the cylinder (6), thus forming a reservoir (8) of the powder. The speed of rotation of the cylinder, the stress of the blade on the cylinder and the speed of passage of the coated substrate are set so as to obtain the deposition of a fine film of single-unit and nonsuperposed individualized grains on the substrate.

In the present example, the diameter of the metal cylinder is equal to 50 centimeters, while the blade has a thickness of 0.25 millimeters for a length of 8 centimeters. The speed of rotation of the cylinder is 150 revolutions/minute and the speed of passage of the coated substrate is equal to 150 meters/minute. The powder is deposited in an amount of 3 g/m². The complex obtained is then dried in an oven at 130° C. for 5 seconds.

4/Preservation of Roses

8000 budding roses were gathered in Central America. The 8000 roses were packaged in containers of 300 consisting of 10 batches of 30 using a paper strip manufactured according to the process previously described, having a length of 1 meter and a width of 25 centimeters. The packaging paper is kept near the buds as shown in FIG. 3a (front view of flowers) and 3b (side view of flowers). As shown in the figures, all the roses are positioned near the device so that the treatment is uniform.

After 6 days of transportation between Central America and France, the buds of the roses remained identical, the stem is still hard and the flowers have not withered. The roses are then kept in the open air at a temperature of 25° C. After 3 weeks, no sign of decay is visible.

In addition, it is observed that the aging process in the rose is delayed. Indeed, whereas it starts on the 10th day for a normal rose, it is delayed to the 35th day for a rose treated with the device of the invention.

The invention and the advantages resulting therefrom are clearly evident from the preceding description.

There will be noted in particular the small quantity of powder used for making the device, thus leading to the cost of the preservation treatment being considerably reduced.

In addition, it is noted that the storage life is very long, and that the maturation phenomenon is slowed down.

Finally, the preservation of the plants is uniform under normal storage conditions.

1. A device for protecting plants against decay, comprising a mixture of powders capable of adsorbing, then eliminating, by breakinq of the double bond, the ethylene released by said plants, which is in the form of a substrate coated with an adhesive layer, whose surface is covered with said powder mixture, which is in the form of a film of single-unit and individualized grains, of which part of the surface remains outside the adhesive layer, the powder being deposited on the adhesive layer in an amount of 0.1 to 60 g/m² on a dry basis.

2. The device as claimed in claim 1, characterized in that the mixture of powders comprises an inert material chosen from the group comprising activated alumina, activated charcoal, clay, dolomite, zeolite, diatoms, perlite, bentonite, activated kaolin, titanium dioxide, alone or as a mixture.

3. The device as claimed in one of the preceding claims, characterized in that the mixture of powders contains a hygroscopic salt chosen from the group comprising calcium, magnesium, sodium or potassium chloride, nitrate, carbonate or sulfate, calcium or magnesium hydrides, and polysulfates, alone or as a mixture.

4. The device as claimed in one of the preceding claims, characterized in that the mixture of powders also contains an oxidizing agent chosen from the group comprising potassium salts, sodium salts, manganese salts, osmium tetroxide, alone or as a mixture.

5. The device as claimed in one of the preceding claims, characterized in that the mixture of powders comprises, in addition, sodium carbonate or bicarbonate.

6. The device as claimed in one of the preceding claims, characterized in that the mixture of powders comprises, in addition, iodine salts or pure iodine.

7. The device as claimed in one of the preceding claims, characterized in that the substrate is a fibrous substrate or a nonfibrous substrate.

8. The device as claimed in claim 7, characterized in that the fibrous substrate is chosen from the group comprising packaging paper in particular of the glassine, parchment paper and kraft paper type.

9. The device as claimed in claim 7, characterized in that the nonfibrous substrate is in the form of a plastic film whose constituent material is chosen from the group comprising polyethylene, polypropylene, cellophane, alone or as a mixture.

10. The device as claimed in one of the preceding claims, characterized in that the adhesive layer comprises a binding agent chosen from the group comprising starch, carboxymethylcellulose, polyvinyl alcohol, emulsifiable homo- or copolymers of the acrylic, styrene and butadiene type and derivatives, alone or as a mixture.

11. The device as claimed in claim 10, characterized in that the concentration of binding agent in the adhesive layer is between 1 and 20%, advantageously 5%, as dry matter.

12. The device as claimed in either of claims 10 and 11, characterized in that the adhesive layer is coated on the substrate in an amount of 0.5 to 15 g/m², advantageously 3 g/m² on a dry basis.

13. The device as claimed in one of the preceding claims, characterized in that the powder is deposited on the adhesive layer in an amount of at least 0.1 g/m² on a dry basis, advantageously 2 to 5 g/m².

14. The device as claimed in one of the preceding claims, characterized in that the size of the grains constituting the mixture of powders is between 20 and 500 micrometers, advantageously 150 micrometers.

15. A method for making the device which is the subject of one of claims 1 to 14, characterized in that it comprises the following steps:
the adhesive layer is first of all coated onto the substrate;
then, the powder mixture is deposited on said adhesive layer so as to obtain a fine film of homogeneously distributed single-unit and individualized grains,
finally, the complex obtained is dried so as to evaporate the solvent present in the adhesive layer.

16. The process as claimed in claim 15, characterized in that the making of the mixture of powders consists:
in mixing, with stirring, the various constituents of the mixture of powders with water until a paste is obtained;
then, in extruding the paste thus obtained, through a die;
in then evaporating the water by drying;
in then grinding the product obtained until a powder is obtained;
finally, in calibrating the powder by sieving.

17. The method as claimed in claim 15, characterized in that the powder is deposited by means of a cylinder equipped with a blade forming a powder reservoir, the diameter of the cylinder being between 10 and 70 centimeters, advantageously 50 centimeters, the speed of rotation of the cylinder will be between 100 and 600 revolutions/minute, advantageously 150 revolutions/minute.

18. The method as claimed in the preceding claim, characterized in that the substrate coated with the adhesive layer passes under the powder curtain at a speed of between 100 and 200 meters per minute, advantageously 150 meters per minute.
